(19) United States
(12) Patent Application Publication
(10) Pub. No.: US 2006/0080103 A1
(43) Pub. Date: Apr. 13, 2006

(54) Method and system for network downloading of music files

(75) Inventor: Albertus J. N. Van Breemen, Lommel (BE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/539,984

(22) PCT Filed: Dec. 11, 2003
(86) PCT No.: PCT/IB03/05993

§ 371 Date: Jun. 19, 2005

Related U.S. Application Data
(60) Provisional application No. 60/434,551, filed on Dec. 19, 2002.

(51) Int. Cl. G10L 21/00

(52) U.S. Cl. 704/270

(57) ABSTRACT

The invention presents a method for network downloading of music files by obtaining at least one music preference and accessing at least one network based music file, the music file including at least one music attribute. The music attribute is compared to the music preference, and the music file is downloaded based on the comparison.

In general, the invention relates to music collection. More specifically, the invention relates to the selection of music files within a network and in particular, to a method for network downloading of music files as a function of a music player.

Digital cameras, camcorders, digital VCRs such as the Tivo, Internet radios, game consoles such as the X-Box, Internet-enabled refrigerators, and MP3-players are a few of the consumer electronic devices that have been influenced by recent Internet and computer technologies. New kinds of applications are possible when the more “traditional” device functionalities (such as playing and recording music and video's) are combined with Internet enabled services, such as providing information and e-commerce.

Portable MP3 and other music playing devices have significantly increased in their capabilities. Hard drives (internal disk storage devices) have been installed into music players to allow for the storage of thousands of songs. Additionally, many devices capable of playing music files now have the added feature of an Internet connection via a wireless modem. This allows the possibility to download songs directly from the Internet to the music (MP3) player. Due to the limited user interface that these devices have however, make it very impractical to gather large numbers of the music files available over network (Internet) connections.

Current Internet enabled personalized music playing devices with hard drive storage have capacities ranging from 1667 songs (5 Gb) to 10000 songs (30 Gb). A problem these music players (and the like) have is that they rely on the customer (user) to determine how and where to get the music content from that is to be loaded on his/her music player. Because of the limited user interfaces available for the music players, the user has to enter the exact name and location of each song they wish to be transferred to the player.

Thus, there is a significant need for a method and system for downloading music files over a network that overcomes the above disadvantages and shortcomings, as well as other disadvantages.

One aspect of the invention presents a method for network downloading of music files by obtaining at least one music preference, accessing at least one network based music file, the music file including at least one music attribute, comparing the music attribute to the music preference, and downloading the music file based on the comparison.

Another aspect of the invention provides a system for network downloading of music files. The system includes means for obtaining at least one music preference, means for accessing at least one network based music file, the music file including at least one music attribute, means for comparing the music attribute to the music preference, and means for downloading the music file based on the comparison.

Another aspect of the invention provides a computer readable medium for storing a computer program for network downloading of music files. The computer program is comprised of computer readable code for obtaining at least one music preference, computer readable code for accessing at least one network based music file, the music file including at least one music attribute, computer readable code for comparing the music attribute to the music preference, and computer readable code for downloading the music file based on the comparison.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

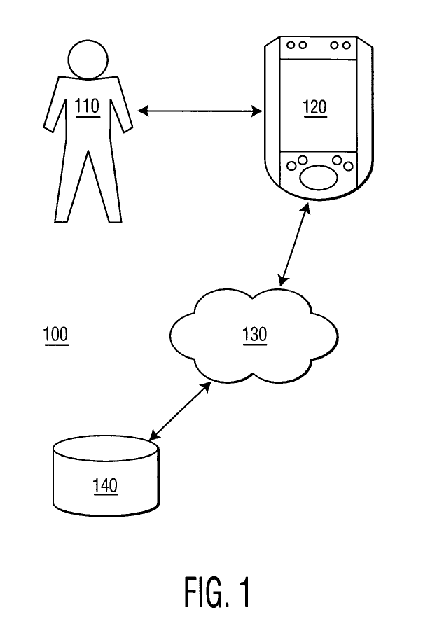

FIG. 1 is a schematic diagram for one embodiment of a system for accessing and downloading music files, in accordance with the current invention;

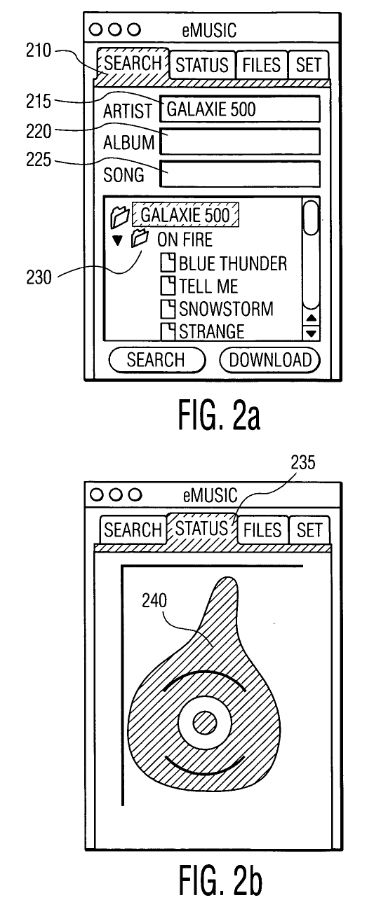

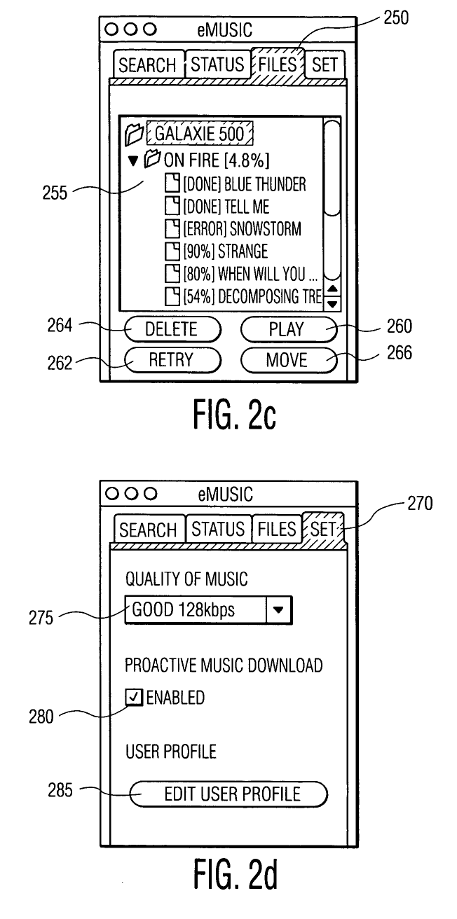

FIGS. 2a-2d are illustrations for one embodiment of a graphical user interface utilizing the system of FIG. 1, in accordance with the current invention;

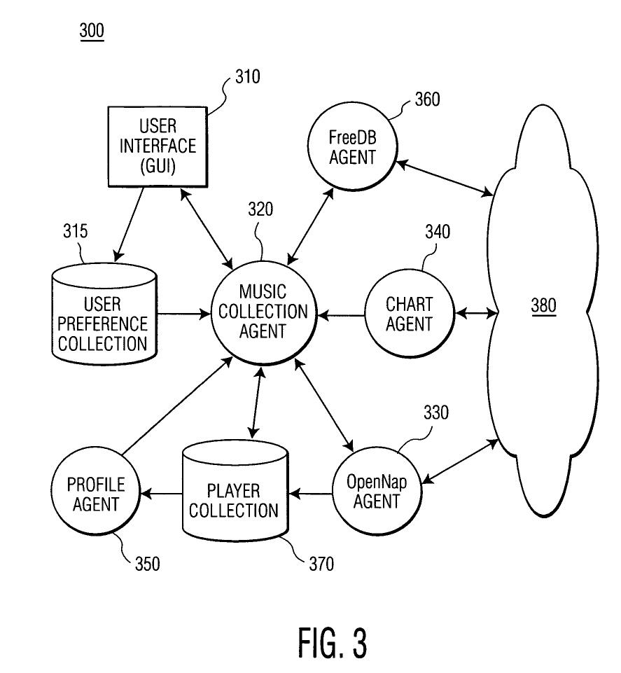

FIG. 3 is a block diagram for one embodiment of a proactive music gathering method utilizing the system of FIG. 1 and FIGS. 2a-2d, in accordance with the present invention;

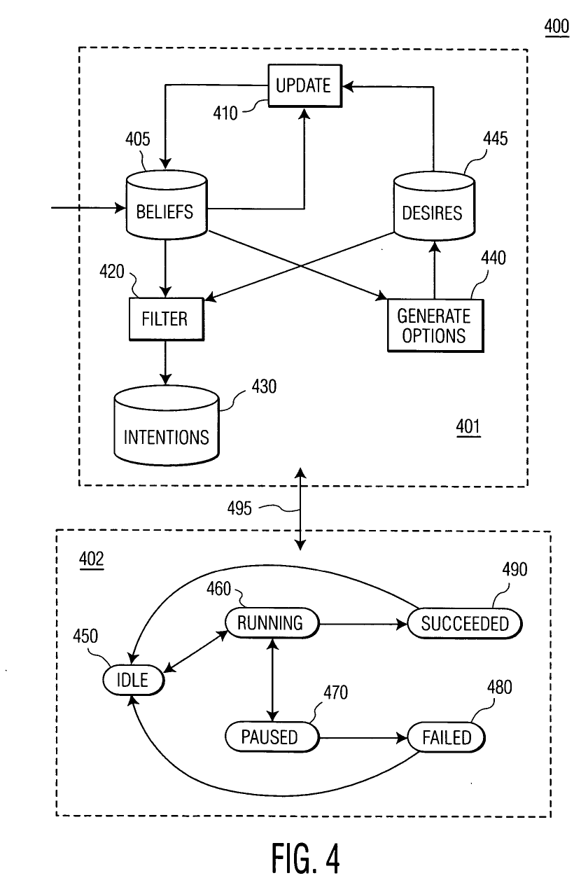

FIG. 4 is a block diagram for one embodiment of a flexible reasoning method utilizing the system of FIG. 1 and FIGS. 2a-2d, and the method of FIG. 3, in accordance with the current invention;

FIG. 5 is a block diagram for one embodiment of a Profile agent utilizing the system of FIG. 1 and FIGS. 2a-2d, and the method of FIG. 3 and FIG. 4, in accordance with the current invention;

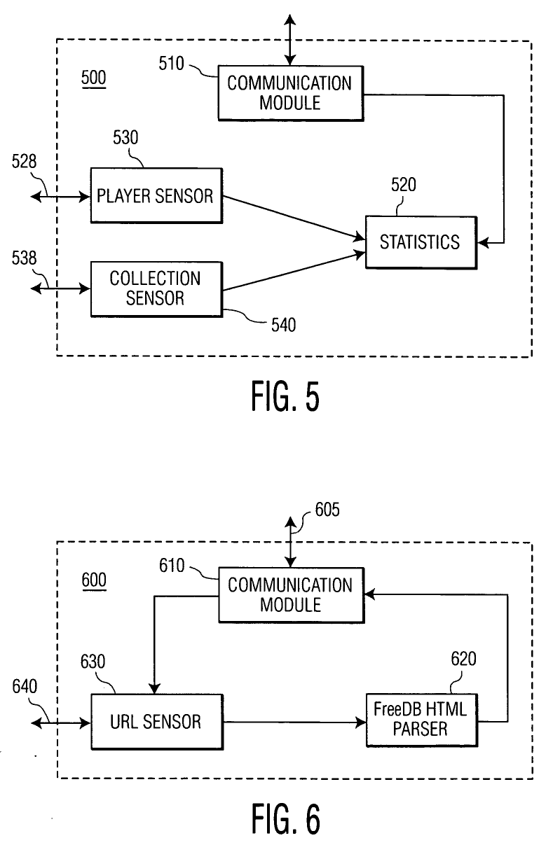

FIG. 6 is a block diagram for one embodiment of a FreeDB agent utilizing the system of FIG. 1 and FIGS. 2a-2d, and the method of FIG. 3 and FIG. 4, in accordance with the current invention;

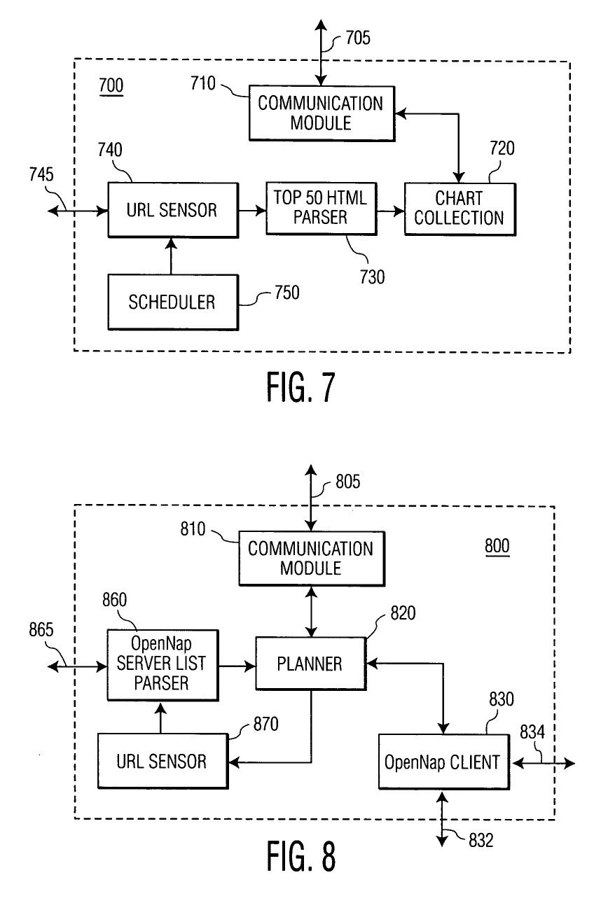

FIG. 7 is a block diagram for one embodiment of a Chart agent utilizing the system of FIG. 1 and FIGS. 2a-2d, and the method of FIG. 3 and FIG. 4, in accordance with the current invention; and

FIG. 8 is a block diagram for one embodiment of an OpenNap agent utilizing the system of FIG. 1 and FIGS. 2a-2d, and the method of FIG. 3 and FIG. 4, in accordance with the current invention.

Illustrated in FIG. 1 is a schematic diagram for one embodiment of a system 100 capable of accessing and downloading music files, in accordance with the current invention. The system 100 includes a user 110, a music playing device 120, a network connection 130, and a music collection 140.

The user 110 is any person who operates the music playing device 120, and may be referred to as user, person, or customer. The music playing device (MP3 player, M-player, music player, player) 120 includes MP3 players, personal computers, personal digital assistant (PDA), portable computers, and hand held communication devices such as an analog or digital phone, and may have suitable hardware and software for transmitting and receiving network data communications. In one embodiment, the music playing device 120 further includes a wireless modem for transmitting and receiving data. In one example, the music playing device 120 may be an analog mobile telephone operating over a prescribed band nominally at 800 MHz, or the music playing device 120 may be a digital mobile telephone operating over a prescribed band nominally at 800 MHz, 900 MHz, 1900 MHz, or any suitable band capable of carrying mobile communications.

In a further embodiment, player 120 contains a speech recognition system (ASR) capable of communicating with the network 130, and contains a voice recognition engine (VRE) capable of word recognition. An additional embodiment of the player 120 provides that it is capable of functioning as any part of, or as all of the above embodiments. In another embodiment of the invention, player 120 is capable of data storage, and/or data retrieval, and/or receiving, processing, and transmitting data queries. In yet another embodiment, the player 120 includes an audio speaker, a synthesized voice output, the audio portion of a television, a display device, an audio channel, or the like.

The network 130 is wireless or fixed and for one embodiment of the invention includes the Internet. In another embodiment, the network 130 is any computer network capable of accessing a network server, file server, application server, and/or database server. The music file collection (music database) 140 is for another embodiment of the invention a database, and may reside in a database server. In yet another embodiment of the invention, the music file collection 140 may be a system capable of accessing or storing a music file, personal audio collection, or music compact disks (CD's). The music file is of any format known in the art suitable for transmission over the network 130 and playing on the music playing device 120.

The system 100 is capable of providing methods for a user (customer) 110 to obtain songs (music files) from a music database 140, and temporarily or permanently store the music files on music playing device 120. One such method allows the user 110 to digitalize his or her personal audio collections (CD's) and put them in a compressed format, such as MP3, onto his or her player 120. Another method provides that the system utilize a network connection such as the Internet 130 to collect songs from a music database 140. Additionally, a method of sharing music files is quite popular, therefore Internet-based file sharing services are embedded into one embodiment of the music playing device 120. Additional embodiments of the player 120 have embedded information about the existence of music-items such as songs and albums, and may include the type of music the user 110 prefers or requests. A profile of the user 110 may be necessary to provide at least one music preference for embodiments of this type. This profile contains information about the preferences of the user with regard to music aspects (artist, year, label, title), information about the music collection of the user, and the user's playing behavior. Another embodiment of the player 120 has the capability of collecting, reading, and writing meta-data as is known in the art, about music items. The meta-data may provide the player 120 with attributes associated with music files and may include artist, title or release year of a song or album, and the track information of an album. Another embodiment of the system 100 provides that information about network 130 accessible download sites (databases) 140, to be embedded within the player 120.

An embodiment of the invention is illustrated in FIGS. 2a-2d, depicting assorted views of a graphical user interface (GUI) for use with a music gathering application. This embodiment suits the condition that a user does not need to know all the details about the events that are generated by the downloading or playing of music files. When the user takes a quick look at his or her player, he or she may only want to roughly know how well the music gathering progresses. If the progress is unsatisfactory, the user may want to take actions to resolve the problem. In the embodiments illustrated as FIGS. 2a-2d, the GUI is used to coordinate and summarize the information complexity of music gathering and downloading.

All four of the illustrations have shared characteristics (overall embodiments) encompassing the shared properties of FIG. 2a, FIG. 2b, FIG. 2c, and FIG. 2d. The first overall embodiment provides that the interface (GUI) for a music gathering application is optimized to a screen size of 240×320, which is a standard size for many players known in the art. A second overall embodiment provides that the interface is split into tabs illustrating steps the user may perform in order to gather music; the tabs for one embodiment of the invention correspond with FIG. 2a, FIG. 2b, FIG. 2c, and FIG. 2d.

A search tab 210 highlighted in FIG. 2a shows an embodiment a user can use to aid in the network search for music files. The embodiment of FIG. 2a provides a window (input location) for the user to enter an artist name 215, album 220, or song 225 he or she would like to gather. The result of the search is displayed in the form of a hierarchical tree structure 230, ordered by artist, album and song. If the user, for example, is looking for music of the band “Galaxy 500” then the result field will display the albums of this band and within these the songs that belong to each album. The user may now select, using input devices known in the art, any combination of albums and songs that he or she would like to gather.

A status tab 235 highlighted in FIG. 2b shows an embodiment for the feedback or current status of a music gathering action. The numerous aspects of this status, such as the number of available servers, speed of the download and the availability of chart information are too complex to be visualized given the small screen size, therefore a comic character face (character) 240 is used for one embodiment of the invention. The character 240 acts as an emotional interface, providing a natural and instant feedback to the user by means of emotional facial expressions, to communicate the status of the music gathering application to the user. A simplified OCC emotion model (the emotion model of Ortony, Clore, and Collins) as is known in the art, is used to map the numerous events and actions to emotional states and their intensities. A subsection chosen from the OCC model focuses on the well-being type, creating the character 240 expressions that communicate the internal emotional state of the music gathering application to the world. The well-being type emotions are mapped to a set of three different emotional expressions: happiness, anger and sadness. In short, all the positive events and actions will result in happiness, all the negative events will result in sadness and all the negative actions will result in anger.

The distinction between an event and an action is based on accountability. It is impossible to blame a person for an Internet connectivity failure, but if a specific person at a separate network connection other than the player cancels the download of the user, then the character can be “angry” at that person. The intensity of each emotional state is based on predetermined variables for one embodiment of the invention.

Four events are identified in this embodiment of the invention that are relevant for the synthesis of emotions. First, a NewChartInfo event is generated whenever a Chart Agent (described below) has obtained new hit chart information from the Internet. New chart information makes the character 240 happy. A second event is the NewGoal event. A Music Collector Agent (described below) generates this event when it has decided to obtain a new song or album. Creating new goals makes the character 240 happy as well. A third event is the NewOpenNapInfo event. It is generated by an OpenNap Agent (described below) when new information about OpenNap servers has been found. Because this information increases the likelihood of obtaining songs, the character 240 will be happy when this event occurs. Finally, a SearchResult event is the fourth event in this embodiment of the music gathering application that is relevant for generating emotions. The SearchResult event is generated by the OpenNap Agent after the OpenNap Agent has searched for users that share a particular song. When there are users sharing a chosen song the character 240 will be happy; if there are no users sharing the song or if the song can not be found, the character 240 will become sad.

Besides events, actions of agents are relevant for the synthesis of emotions. The user within this embodiment can perform two kinds of actions. The user may perform a UserRequest action to instruct the music gathering application to download a particular song or album, or the user may perform a CancelUserRequest action to abort downloading a particular song or album. The character 240 will become happy when the user requests to download a song or album and it will become angry when the user cancels a request, especially when the application has almost completed the download. The following table lists the emotional intensity of the character 240 as invoked by events and associated variables.

| Events (happy & sad) | Variables to calculate intensity |
|---|---|
| NewChartInfo | Probability of happening, number of |
| | new hits. |
| NewGoal | Probability of happening, goal type. |
| NewOpenNapInfo | Probability of happening, number of |
| | new OpenNap servers. |
| SearchResult | Number of results. |

The next table lists the emotional intensity of the character 240 as invoked by actions and their associated variables.

| Actions (happy & anger) | Variables to calculate intensity |
|---|---|
| UserRequest | Last time user made a request, type of |
| | music item requested. |
| CancelMusicItem | The progress status of the request. |
| GetAlbumInformation | Probability of success, actual success |
| | or failure state of the action. |
| ConnectToAnyServer | Probability of success, number of failed |
| | ConnectToSpecificServer actions. |
| ConnectToSpecificServer | Probability of success, last time a |
| | successful connection was made. |
| DownloadFromAnyuser | Probability of success, number of failed |
| | DownloadFromSpecificUser actions. |
| DownloadFromSpecificUser | Probability of success, last time a |
| | successful download occurred. |
| DownloadedSomeBytes | Probability of success. |
| DownloadAbortedByPeer | Probability of happening, progress status |
| | of download. |

A FreeDB Agent (described below) performs the GetAlbumInformation action when the Music Collector Agent requests information about an album. When the action succeeds and information is found about an album, the character 240 will become happy, otherwise the character 240 becomes angry.

One embodiment of the OpenNap Agent performs five actions. A ConnectToSpecificServer action is part of a ConnectToAnyServer action. Both actions are used to connect to an OpenNap server. A DownloadSomeBytes action is part of a DownloadFromSpecificUser action, which in itself is part of a DownloadFromAnyUser action. All three actions are performed when the OpenNap Agent wants to download a song. Finally, a DownloadAbortedByPeer action is any action performed by a peer (user) that stops or prevents the downloading of a file, which the OpenNap Agent has located. This action makes the character 240 angry.

The emotional intensity of the events and actions is calculated by using relevant variables that are listed in the above tables. The intensity of a NewChartInfo event, for example, is based on the probability of this event to happen and the number of new hits that has been retrieved. The character 240 will be happier in cases where the probability of the NewChartEvent is low and the number of new hits is large. The intensity of a CancelMusicItem action is based on the progress of the request. For example, the more effort, in terms of download completion, that has been made to fulfill the request the angrier the character 240 will be if the request is canceled. Finally, the ConnectToAnyServer action is composed of several ConnectToSpecificServer actions. In order to connect to a server the application has to try several specific servers. The intensity of the character 240 reactions to the ConnectToAnyServer action depends on how quickly the application can normally connect to a server (probability of success) and the number of times it had to try a specific server before it had a connection.

The files tab 250 of FIG. 2c displays the files that are currently in the download directory 255 of the application. All songs that the user downloaded, including the ones being currently processed, are shown in a hierarchy tree. This tree structure allows the user to select any combination of artist, album and songs and to perform actions on the selection. The user may for example, listen (play) 260 to a song to check its correctness and quality or retry 262 downloading songs that have not been completely downloaded due to an error. Moreover, the user can delete 264 songs of any artist or album or move 266 them to a database such as the music library of a jukebox application.

In the settings (set) tab 270 of FIG. 2d, the user can adjust the system preferences. The proactive music gathering can be switched 280 on an off, the user's music profile can be edited 285 and the desired music quality for the downloaded songs can be selected from a predefined list 275.

An additional embodiment of the invention combines speech technology (voice recognition) with the GUI to improve the usability of the music gathering application. In this embodiment, the user is able to enter his or her search query, select actions and check on the status of the gathering by using speech. The screen character provides natural feedback of the status of the dialogue by providing conversational and emotional facial expressions.

Additional embodiments of the invention (not shown) include a “gather more” action or button in which additional music of a particular artist is queried (searched for). Furthermore, the character 240 and GUI features of FIG. 2a, 2b, 2c, and 2d are customizable, allowing for feature rearrangement, graphical alteration, and macro program development.

Another embodiment of the invention generates a good initial user profile by analyzing the metadata of the user's existing music collection. The reliability of the user profile increases as the users collection of MP3 files increases. Additionally, the character 240 can become the personal DJ for the user. Supported by proactively downloaded music, the personal DJ generates personalized play lists that the player or a jukebox application uses to create a radio program simulation for the user. The personal DJ is context aware and generates activity-attuned play lists for birthdays, romantic evenings or parties. In another embodiment, the downloaded content of the music gathering application is not limited to music, but includes the latest stock market information, traffic report, and news. The personal DJ also helps improve the accuracy of the application's user profile by engaging the user in a game like setting. In a playful fashion, the application receives feedback on the user's music preferences indirectly or directly, by asking questions of the user.

Further embodiments of the GUI include functions (buttons) to play, pause, stop, record, forward and rewind a song. In another embodiment of the invention, a “Complete Album” feature assigned as a button or function is included as part of the user interface of the audio device (player), similar to the buttons “play”, “stop” or “random play”. Once pressed, the player will obtain the complete album to which the current playing or selected song belongs. These songs may be obtained from the Internet, or from a radio broadcast. In this way, a user can easily listen to a complete album, upon retrieving one file (music file) of that album.

FIG. 3 is a block diagram for one embodiment of a method for proactive music gathering 300 and is embedded within the music player, in accordance with the present invention. This embodiment of the music gathering application (application) 300 automatically obtains music from the Internet based on the user's profile. For one embodiment of the invention, this may include features, functions, and programming for obtaining at least one music preference, accessing at least one network based music file in order to read at least one of the music attributes, and comparing the music attribute to the music preference. The music file can then be downloaded over the network based on the comparison. Another embodiment of the invention allows for the user to integrate with the gathering and downloading of music over a network using key strokes, the graphical interface, or voice commands associated with a voice recognition system.

In order for one embodiment of the music gathering application 300 to function properly, four pieces of information are identified that are essential for a proactive music gathering application. First, the application 300 should have information about the existence of music items such as specific songs and albums. This information is needed in order to know in general what music items exist and can be downloaded. Second, the application 300 should know what kind of music the user likes and what specific requests the user may have. Thus, the application needs a profile of the user. This profile may contain information about the preferences of the user with regard to particular music aspects. These aspects may include artist name, year of recording, label of distributor, title of song, and title of album. The profile may also contain information about the whole music collection within the player, and the user's music playing behavior. Third, the application 300 should have metadata about the music items it retrieves or stores. For example, the application should have access to metadata for the artist, title or release year of a song or album, as well as for which tracks and how many tracks are on a particular album. Metadata may be used to determine which music items are liked or disliked by the user. Finally, the fourth information need is about places where to download the music items, e.g. information about download sites on the Internet.

In order for the music gathering application 300 to use the four pieces of information, the information must be formally represented in some way. Therefore, a formal, explicit specification or ontology of a shared conceptualization is developed. The conceptualization for one embodiment of the invention, refers to a model of the music domain, including the fact that this domain contains concepts such as songs, albums, download site, artist, genre, user preferences, as well as relations between these concepts, such as the fact that songs have certain music aspects (artist, title, genre) and that albums have tracks. The ontology language used was adopted from the DESIRE method, which is an overall design method for agent systems that is known in the art.

The architecture for the music gathering application 300, applies several composition principles. First, a differentiation between non-agent and agent components is made. The non-agent components of the music gathering application 300 and its related system architecture reflect traditional components such as collections/databases and media (MP3) playing software components. The agent components reflect components that actively make decisions and whose behavior can be explained by adopting an intentional stance by attributing beliefs, desires (goals) and intentions to them. A second composition principle applied in application 300 uses a central agent along with support agents in the application architecture. The central agent is used for solving the problem of “what music items to obtain” and sets application level goals. The support agents provide the central agent with relevant information from the Internet and are responsible for addressing the problem of “how to obtain a particular music item”. Finally, the application 300 uses the mirroring of external (Internet) resources composition principle, as is known in the art. Briefly stated, for every relevant information source on the Internet, an agent is designed that includes the protocols to obtain any required information, and to translate the information into an internally specified format that is understood by the components of the application architecture.

An additional embodiment of the music gathering application not illustrated, structures the application as a single agent. In this embodiment, one agent is responsible for several tasks, such as gathering information from the Internet, deciding which music items to obtain and downloading files. The single agent application structure consists of only one main component with a high degree of internal complexity to design.

The multi-agent method used by the application 300 provides for the use of modular software components that are incrementally developed and deployed, and have a higher level of reuse. As mentioned above, the music gathering application 300 consists of two types of components, non-agent and agent components. The non-agent components include a User Preference Collection 315 which is a component that contains the user's preferences about music aspects such as artists, genres, etc; a User Interface or GUI 310 as described in FIG. 2; an MP3 (or alternative music file) Player component that plays MP3 (or alternative music) files; and a Player Collection 370 component which is a component that contains all the MP3 (or alternative music) files of the user. These components are internally structured using traditional software engineering techniques.

The agent components used by the application 300 include a Music Collector Agent 320, which is a central agent that reasons which music items to obtain; an OpenNap Agent 330, which is a support agent that handles the problem of downloading MP3-files from OpenNap servers on the Internet 380; and a Chart Agent 340, which is a support agent that monitors particular Internet sites that contain hit chart information. When new chart information becomes available, the Chart Agent 340 may also parse the Internet 380 site and send new information to the Music Collector Agent 320. Additional agent components used by the application 300 include a Profile Agent 350, which is a support agent that generates a profile of the user based on information about the user's music collection, and on the user's playing/listening behavior; and a FreeDB agent 360, which is a support agent that accesses the FreeDB Internet 380 site (an open source online database with metadata about albums) to obtain information about the tracks of an album.

The internal architecture of the individual agents is attuned to the functions they address and therefore, each agent has a different internal architecture. First, the Music Collector Agent 320 has to make inferences about the music items the user probably likes. The embodiment of the invention illustrated in FIG. 3 adopts a Belief Desire Intention (BDI) architecture that enables the Music Collector agent to make the required inferences. The BDI architecture is well known within the field of agent theory but alternative architectures known in the art may be used.

Second, the OpenNap Agent 330 effectively downloads music files from OpenNap servers. The OpenNap Agent's 330 architecture is based on reinforcement learning techniques in order to address the problems of OpenNap servers. These problems include servers and users connecting and disconnecting from a network in an unpredictable manner, some users not sharing files or having a limit on the number of uploads allowed, and not every server sharing the same set of files.

Third, the task of the Chart Agent 340 is relatively simple compared to the former two agents because it only needs to parse Internet sites (html documents) with hit chart information periodically. The Chart Agent 340 has a dedicated architecture for this purpose.

Forth, the Profile Agent's 350 architecture is based on statistical techniques to calculate statistics about the Player Collection 370 and the user's playing behavior.

Finally, the FreeDB Agent 360 has, just like the Chart Agent 340, a dedicated architecture that implements the protocol to access an online FreeDB music database.

The software components of the music gathering application 300 should meet not only functional requirements but, also a number of more subtle non-functional requirements. The non-functional requirements include: ease of creation, security, interoperability, integrability, operability, responsiveness, attractiveness, efficiency, expandability and stability. The non-functional requirements will be explained below in detail.

Ease of creation is defined as the degree of effort to create the music gathering application 300 according to stated requirements.

In general, security is defined as the prevention of unauthorized access to programs and data. In addition, for the music gathering application 300 it is in the interest of the user being the device owner, to keep his personal data and profiles local to the device. In one embodiment of the invention, it is a requirement that any information describing the user is not disclosed to one or more service providers. This requirement has the effect of ruling out the typical recommended system architecture where data of several customers are correlated and easily accessible.

Interoperability for the embodiment of FIG. 3 refers to the ability of the application to interact with a number of specified systems, for example OpenNap and FreeDB servers, to obtain music files and music metadata. Not only does the application 300 conform to the pertinent protocol standards in a formal sense, it also interoperates efficiently, adapting to the timing characteristics of the peers and servers encountered during runtime. The architecture of FIG. 3 supports interoperability by the separation of concerns. In one embodiment, for example, the protocol details and data formatting conventions of OpenNap, hit charts sites, and FreeDB are each encapsulated in a separate agent. These agents do not deal with one fixed server or one fixed peer, but dynamically find and evaluate servers and peers on the Internet 380.

Integrability is defined as the degree to which components and embodiments of the application 300 can easily be integrated. Integrability is achieved in one embodiment of the invention by using shared data structures. Another embodiment achieves integrability by using dedicated interfaces, based on patterns such as a users listening pattern.

Operability is defined as enabling the user to operate and control the music gathering application 300. In one embodiment of the music gathering application 300, operability must take away most, if not all, of the cognitive load from the user. With regard to this embodiment of the invention, the user has no need to program the sequence of music fragments to be played, to keep track of download statuses, or to remember the IP addresses and other characteristics of peers and servers.

Responsiveness refers to the ability of the application 300 to react fast enough according to the users expectations and, also, refers to the ability of the application 300 to provide sufficient feedback during processing. The application 300 provides a method that reacts fast according to the users expectations, because the MP3 Player and the Music Collector Agent 320 run as parallel threads.

Attractiveness is defined as ‘to be liked by the user’ and for this embodiment of the invention translates to the functional requirement that application 300 gathers music items liked by the user, gathers music items listed on music rating charts, and takes user feedback and music availability into account. With respect to operability and attractiveness, the agents of the application 300 take away most, if not all, of the cognitive load from the user by going to the Internet 380 and gathering preferred music without the need for user intervention.

Efficiency is defined as appropriate time behavior and appropriate resource utilization, allowing the music gathering application 300 to operate with different systems and architectural platforms. Efficiency, for example appropriate time behavior and appropriate resource utilization, is achieved in one embodiment of the invention by the real-time aspects of MP3 (or like music format) playing and Internet protocol handling being provided by separate components, each having their own threads. A problem may be encountered with the handling of a large number of parallel tasks, each of which can be slow or even can fail, when processed one by one by the Music Collector (collection) Agent 320. An “action execution” mechanism deals with this problem by providing that parallel work happens outside the application, somewhere on the Internet. In addition, the OpenNap agent 330 is intelligent in the sense that it learns to stay away from slow and unreliable servers and clients, which of course makes the application more efficient.

Expandability refers to the ease at which the applications functionality or performance can be increased to meet new needs. Closely related to expandability, is stability. Stability refers to the minimal effects caused by the modification of the application 300.

The Music Collector Agent 320 plays a central role in the application architecture as it sets the application goals. One embodiment of the Music Collector Agent 320 decides which music items (songs/albums) to download for the user based on the information it has obtained from the other agents and the user, and based on information from the Preference Collection 315 and the MP3 (player) Collection 370 components. Once the Music Collector Agent 320 has determined which music items to download, it sends a request to the OpenNap Agent 330.

In order for the Music Collector Agent 320 to determine which music items to download, it must be capable of analyzing the information it has received. A flexible reasoning mechanism that is dedicated to operate within such a practical problem domain as the Internet 380 is essential for the proper functioning of the Music Collector Agent 320. As mentioned above, the BDI architecture may be used for this purpose. The BDI architecture contains three sets of information. First is a set of Beliefs, which contains information about the agent's environment and internal state. In the application 300, this may include information about music items and their aspects, and information about the preferences and requests of the user, the songs in the MP3 Collection and specific information about aspects of music items. Second, is a set of Desires that contains information about the objectives or goals of the Music Collector Agent 320. In the application 300, the goals may include obtaining music items with a particular music aspect, or may include the desire to have information about the tracks of an album. Third, is a set of Intentions that contains information about the actions an agent will execute in order to realize its desires. In order to reason and control actions the Music Collector Agent 320 must have an internal representation of actions. An ontology has been designed for this purpose such that the agent can reason about the state of the actions it is carrying out. In the BDI architecture, the ‘Action execution’ function will update the set of beliefs if the state of an action changes. In addition, if the set of Intentions contains a statement to control an action, the set of Intentions may be translated by the ‘Action execution’ function into an actual control of action.

Illustrated in FIG. 4 is a block diagram for one embodiment of a flexible reasoning (BDI) method 400. The upper part of this diagram illustrates ‘Logical Reasoning’ 401, that includes three databases representing the three sets of information: Beliefs 405, Desires 445, and Intentions 430. Besides the Beliefs 405, Desires 445, and Intentions 430 sets, a BDI architecture also contains three functions that operate on these sets. The Generate Options function 440 carries out means-end reasoning and thereby generates new Desires (goals). While doing so, it maintains consistency between the Beliefs 405, Desires 445, and Intentions 430. For example, if the Music Collector Agent has a belief that a particular music item is not downloadable, then it must not create a desire to download that song. Another embodiment of this function is to recognize advantageous changes in the environment of the Music Collector Agent. For example, if the belief that a particular music item is not downloadable disappears, it can retry to download that music item.

The Filter function 420 is responsible for three things. First, it drops intentions that are not achievable. Second, it retains intentions that could not be achieved. Third, it adopts new intentions.

The Update function 410 is responsible for updating the set of beliefs with new information. This could be information about the internal state of the application for example, new preferences or user added music files.

The lower part of FIG. 4 illustrates the ‘Action execution’ 402. Most logic based reasoning systems assume that the actions an agent can take are atomic and consume no time, or at least the time an action takes to carry out is not taken into account. In this embodiment of the architecture, that assumption cannot be made as actions, such as downloading files and searching the Internet, take time to complete. It would be inefficient to wait for each action to be finished, therefore, the implemented BDI architecture provides that actions can be executed and that the agent can reason about the state of an action. An action can be compared with a task in a normal computer operating system. In one embodiment of the invention, an action can be in one of five states, 450, 460, 470, 480 and 490. In the IDLE state 450, the action is doing nothing. If an action is created, it will start in this state. Also, when an abort or reset event happens, the action will return to this state. In the RUNNING state 460, the action is executing its program or algorithm for example, a get-info action typically will make a connection to the Internet to find requested information. In the PAUSED state 470, the action is doing nothing. The difference between the PAUSED state 470 and the IDLE state 450 is that the internal state of the program or algorithm of the action is saved and restored if the action is resumed from the PAUSED state 470.

Two states are termination states of the action. In the SUCCEEDED state 490, the action has succeeded. In the FAILED state 480, the action has failed. The events on which transitions between the states occur are depicted as 495. The agent has control over the execute, abort, pause, resume and reset events 495. The transitions to the SUCCEEDED 490 and FAILED 480 states are autonomous and depend on the results of the task implemented by the action.

The music domain knowledge contained by the three functions, Generate Options 440, Filter 420, and Update 410 of the BDI architecture is represented in our implementation by rules. A rule consists of an antecedent and a consequent. If the antecedent is true then the consequent is executed. For example, the Generate Options 440 function contains, among others, the following rules:

% Rule #1 : download user requests
IF request-obtain-music-item(I:MUSIC ITEM)
THEN selected-goal(obtain-music-item(I:MUSIC ITEM))
% Rule #2 : always download music with aspects the user loves
IF preference(A:MUSIC ASPECT, love it)
THEN selected-goal(acquire-music(A:MUSIC ASPECT))

The first rule states that if the Music Collector Agent has the belief that the user has requested to download a particular music item, then it must set a desire to obtain that music item. The second rule states that if the user loves music with a particular aspect (such as music from ‘Madonna’) then it sets a desire to acquire music items with that aspect. An example of a rule from the Filter 420 function is:

% Rule # : get information about the tracks of an album to download
IF selected-goal(obtain-music-item(A:ALBUM))
AND NOT number-of-tracks(A:ALBUM, N:NUMBER)
AND NOT is-running(get-album-info(A:ALBUM))
AND NOT is-paused(get-album-info(A:ALBUM))
AND NOT is-succeeded(get-album-info(A:ALBUM))
AND NOT is-failed(get-album-info(A:ALBUM))
AND NOT not-available-album-info(A:ALBUM)
THEN to-be-executed(get-album-info(A:ALBUM))
Finally, an example rule from the Update Beliefs function is:
% Rule # : handle result of failed get-album action
IF is-failed(get-album-info(A:ALBUM))
THEN not-available-album-info(A:ALBUM)
AND NOT to-be-executed(get-album-info(A:ALBUM))
AND NOT is-failed(get-album-info(A:ALBUM))
AND NOT selected-goal(obtain-music-item(A:ALBUM))

Another embodiment of the invention is illustrated as a block diagram for a Profile agent 500, as shown in FIG. 5. In order to decide which music items to download, information about the user's music interests is needed. Two types of information are used for this embodiment, preferences and a profile. Preferences are set directly by users. For instance, a user can enter that he or she likes a particular genre and hates a particular artist. In the music domain ontology, this can be expressed by statements such as preference (artist “artist X”, rating HATE IT) or preference (genre “rock”, rating LIKE IT). A profile on the other hand, is information about the user's music interests that is derived automatically, by observing the user.

The Profile Agent 500 has the responsibility to calculate the user's profile. FIG. 5 illustrates the internal architecture of this agent. The Profile Agent 500 uses two sources to calculate the user's profile. The first source is the music (MP3) Player 528. This source is used to make an estimate (statistical analysis) 520 of the user's playing/listening behavior. The second source is the music (MP3) Collection 538. This source is used to estimate 520 the user's more static interests, in particular music aspects. The embodiment provides that from the information of which files a user is playing, an indication can be formed of the user's short term interests, and from the music collection an indication can be made about the user's long term interests, in particular music aspects. Sensors (as are well known in the art with agents) are used to sense the MP3 player 530 and MP3 collection 540. These sensors receive events when, for example, a user pressed the play button, or when a file is added or removed from he MP3 collection. A listening profile can be calculated 520 using the event that the play button has been pressed. If this event happens, the MP3-player sensor 530 receives information about the MP3 file that is being played 528. From the ID3 tag of this file, information about the artist, genre, album, etc. can be derived. For each of these music aspects, a frequency of how often music items with this aspect have been played is calculated by the equation:
Error! Objects cannot be created from editing field codes. (1)

where N is the number of music items that has music aspect A that has been played over the past T time period. This numerical frequency is translated into one of the linguistic values NEVER, RARELY, SOMETIMES, OFTEN or ALWAYS. This is done by using threshold values. The following frequency intervals are defined.

| Value | interval |
|---|---|
| NEVER | fa < once every 2 months |
| RARELY | once every 2 months ≦ fa < once every month |
| SOMETIMES | once every month ≦ fa < once every week |
| OFTEN | once every week ≦ fa < once every day |
| ALWAYS | fa ≧ once every day |

A collection profile is calculate 520 by using the events when a MP3 file is added or removed from the MP3 Collection. The MP3 Collection Sensor 540 is used to detect these events and receives information about the MP3 file 538 that is being added or removed. Again, from the ID3 tag of the MP3 file information about the artist, title, genre, album etc. can be derived. In order to calculate 520 the collection profile for each music aspect, the number of music items that have this aspect is calculated. This number is denoted by na, where a is the particular music aspect. Finally, this numerical number is translated into one of the linguistic values (amount) NONE, SOME, SEVERAL, MANY or A LOT. This is done by using threshold values. The following amount intervals are defined.

| value | interval |
|---|---|
| NONE | na = 0 |
| SOME | 0 ≦ na < 5 |
| SEVERAL | 5 ≦ na < 10 |
| MANY | 10 ≦ na < 15 |
| A LOT | na ≧ 15 |

The Profile Agent 500 is reactive, meaning it calculates the profile only if it receives events from the MP3 player or the MP3 collection. If the profile changes then the profile agent 500 will send the new profile through the communication mode 510 to the Music Collector Agent.

FIG. 6 is a block diagram of one embodiment of a FreeDB agent 600. In order to decide which music items to download, information is needed regarding the music aspects of these items. For example, aspects of a particular song must be known such as the artist and title of the song, or its genre or release date. This kind of information is called meta information. Much meta information is included in MP3 files and is called the ID3 tag of a MP3 file. The first version, ID3v1, had a limited set of fixed-sized field that included the title, artist, year, genre and comment field. Later versions of the ID3 tag solve the problem of fixed-sized fields and allow for various other types of fields.

Although the ID3 tag of MP3 files is a source of information about music aspects of songs, it is not enough to download an album. In order to download an album, knowing what tracks are on it is also required. This information is found in a database on the Internet 640. One such database, the CDDB Internet Service, contains album information, such as information about the tracks on the album. The CDDB Internet Service is often used by media players on personal computers. In practice, when a user puts an audio CD in his or her CD-Rom drive, the media player calculates a (nearly) unique disc identification (ID) that is used as a key to find the album information at the CDDB. Once found, the media player can display track information (artist, title) relating to the audio CD. However, due to changes in the license required for accessing CDDB, an alternative database has been developed called the FreeDB. FreeDB is an open-source, CDDB-like database that contains album information.

The FreeDB Agent 600 is an agent that handles the requests to get information about songs and albums. FIG. 6 illustrated its internal architecture. In one embodiment, a communication module 610 receives requests from the Music Collector Agent 605 to find some information. The requests received are typically in the form of get-info(A:ALBUM). The communication module 610 implements the communication protocols between the FreeDB Agent 600 and the Music Collector Agent 605.

Album information can be found at the FreeDB site by constructing a proper URL that contains the request for information about a particular album. The communication module translates the get-info(A:ALBUM) statement into a URL and sends it to a URL Sensor 630.

The URL sensor 630 makes a socket connection to the Internet 640 and downloads the html text indicated by the URL. The html text is sent to a FreeDB html parser 620. This module parses the text, extracts the album information and puts the information into some internally defined data structure. This data structure is sent to the communication module 610. Finally, the communication module 610 translates the data structure into statements in our music domain language. Typical statements are in the format: number-of-tracks(A:ALBUM, N:NUMBER) and is-track(A:ALBUM, S:SONG, N:NUMBER).

The FreeDB Agent's 600 architecture is a reactive architecture. The agent only undertakes actions if it receives a request and no special reasoning is needed. When the problem of finding information becomes harder, for example, if different sources are available and each have their own properties such as availability, reliability, or quality, reasoning might be needed. In this situation a more deliberative architecture is required.

In FIG. 7, a block diagram for one embodiment of a Chart agent 700 is illustrated. The Chart agent 700 provides hit chart information that is useful for the Music Collector Agent 705 to decide which music items to download. Hit charts are a source of information about music items that exist. In particular, they are a source of any new music item that exists. A hit chart provides the artist name and song title. The Chart Agent 700 has the responsibility of getting a top hit chart each week from the Internet 745. FIG. 7 illustrates the internal architecture for one embodiment of the Chart Agent 700. The Scheduler module 750 triggers the URL Sensor 740 each week to get a ‘musics top hits’ list from the Internet 745. The URL sensor 740 then sends the received html text to the ‘musics top hits’ (TOP 50) html parser 730. This component parses the text in order to get the necessary hit chart information. The TOP 50 html parser 730 sends the text to a chart collection 720 data structure. Finally, the chart collection 720 data structure sends the hit chart information as an internally structures data object to the communication module 710. This module sends the information to the Music Collector Agent 705. The content of the messages are typically in the format: is-hit(S:SONG), has-aspect(S:SONG, M:MUSIC ASPECT).

The Chart Agent 700 is a proactive agent. Every week it checks Internet sites to get new hit chart information.

FIG. 8 is a block diagram for one embodiment of an OpenNap agent 800. The OpenNap Agent 800 is responsible for downloading the requested music files. The OpenNap protocol used is an extension of the Napster protocol. With the Napster protocol, all files reside on the client side. A central server is used to search for files and to initiate the transfer of files. OpenNap servers can be characterized as a highly uncertain, dynamic and non-episodic agent environment. A connection to an OpenNap server is made by using sockets. However, it is unpredictable whether a particular OpenNap server will be up or down at a particular moment. Once a socket connection has been made, the OpenNap Agent 800 has to log into the OpenNap server. Not all OpenNap servers allow everybody to log in (private OpenNap servers) and most servers have set restrictions (e.g. the number of connected users is usually limited to some maximum and every user must share a particular amount of files). If a client has logged in, it can start searching for files. The results of a search request depend on the content being shared by others. Search queries return lists of clients who share particular files and these lists may be empty. If a list is not empty, the client can request another client to start a file transfer. File transfers may also have difficulties. For example, most clients place a restriction on the number of uploads they serve, which causes any user or application past the allotted number that is attempting an upload to be rejected. In addition, when both clients are behind a firewall a file transfer cannot be initiated.

In order to make rational decisions about what to do in the OpenNap environment, the OpenNap agent 800 has to maintain a model of the OpenNap environment. This model should contain an up-to-date list of IP addresses of online OpenNap servers, a profile of every OpenNap server describing the last time when logging in failed and a quality measure composed of the number of successful logins, the number of successful file downloads from this server, a profile of every client describing the last time when a download failed, and an estimation of the probability of a successful download.

FIG. 8 illustrates the internal architecture of the OpenNap Agent 800. The Communication module 810 receives requests from the Music Collector Agent 805 to download particular files. The Communication module 810 sends information to the Planner module 820. The Planner module 820 decides what action to take. The actions the Planner module 820 can choose from include download an up-to-date OpenNap server list, connect to a server, search for a file, download a file, or close a server connection.

When the Planner module 820 decides to download an up-to-date OpenNap server list from the Internet, it sends a trigger signal to the URL Sensor 870. Subsequently, the URL sensor 870 starts downloading an html document from a website 865, for example the Zeropaid.com web site, containing information about online OpenNap servers. This document is sent to the OpenNap Server List Parser 860 that parses the html document in order to get the server information. All server information is put into a data object that is sent to the planner 820.

The Planner module 820 may choose, as an action, to download a MP3 file. Before a music file can be downloaded, a connection to some OpenNap server must be established. Therefore, the Planner module 820 sends a connection request to the OpenNap Client module 830, together with an address of a particular server whose address was obtained previously from the Internet. The OpenNap Client module 830 implements the actual OpenNap protocol over the Internet 832. If the connection fails, the OpenNap Client module 830 sends a message to the Planner module 820. The Planner module 820 may decide to reconnect or to try another OpenNap server.

The procedure to download a music (MP3) file from an OpenNap server starts with a search action. The Planner module 820 sends a request to the OpenNap Client module 830 to search the OpenNap server for a particular file. When the OpenNap Client 830 issues a search request on the OpenNap server, it will receive a list of clients sharing that file. This list is passed on to the Planner module 820 that decides from which client to download the file. It often occurs that a download request is not accepted. The Planner module 820 then decides to download the file from another client. Another embodiment of the invention may provide that after a specific download time has been surpassed, or if a specific number of clients do not accept the request, the request fails and the Planner module 820 disconnects from all open connections. Once all files are downloaded the Planner module 820 requests to close the connection.

The received files are added to the MP3 Collection 834 by the OpenNap Client Module 830. By default, the MP3 Collection 834 sends an event to all listeners when a file is added or removed so that the Music Collection Agent 805 will be notified that there is a new file in the collection. The Planner 820 sends back a notify message to the Music Collector Agent 805 each time a download request of a particular MP3 file has been successful or has failed.

Another embodiment of the OpenNap agent 800 provides that the OpenNap agent 800 learns the quality of clients and servers by using reinforcement learning techniques as are known in the art. In one embodiment of the reinforcement learning technique, the quality (Q) values of servers or users are denoted by Q(server) and Q(client) respectively. These quality values are calculated from ‘rewards’ that are received while trying to download requested files. Rewards are points appointed for each time a logon to a music file server is successful. The quality value of servers is calculated from rewards received after an attempt to login, and after a download session from that server. The user's values are calculated rewards received after an attempt to download a file from that user.

A fragment of the Planner's 820 algorithm to connect and disconnect from an OpenNap server is listed below. The strategy to pick a server is the c-greedy method as is known in the art. Only for a small amount of trials (c %), is a random server selected. During the other trials, the best server is selected; that is, the server with the highest Q value is selected. Algorithm lines 5-10 implement this strategy. A protection to avoid subsequent trials of unsuccessful server logins has been built in. If a login action fails, then the time of this event is remembered. Only after a certain amount of time can a server be selected again.

Updating the Q value of servers is done in lines 15-21 for login rewards.

```
  1: repeat
  2: % update OpenNap server list
  3: ServerList.update( )
  4:
  5: % select an OpenNap Server using ε-greedy method [21]
  6: if RandomGenerator.getNumber( ) < ε1 then
  7: server [symbol] ServerList.getRandomServer( )
  8: else
  9: server [symbol] ServerList.getBestServer(tretry_timeout)
10: end if
11:
12: % try to login
13: server.login( )
14:
15: % update Q(server) by login reward
16: if server.isLoggedIn( ) then
17: Q(server) [symbol] Q(server) + α1[1 − Q(server)]
18: else
19: Q(server) [symbol] Q(server) + α1 [0 − Q(server)]
20: LastTimeFailedLogin(server) [symbol] tcurrent
21: end if
22: until server.isLoggedIn( )
```

The above described methods and systems for network downloading of music files are example methods and systems. These methods and systems illustrate one possible approach for network downloading of music files. The actual implementation may vary from the method discussed. Moreover, various other improvements and modifications to this invention may occur to those skilled in the art, and those improvements and modifications will fall within the scope of this invention as set forth below.

The present invention may be embodied in other specific forms without departing from its spirit or essential characteristics. The described embodiments are to be considered in all respects only as illustrative and not restrictive.

1. A method for network downloading of music files comprising:
obtaining at least one music preference;
accessing at least one network based music file, the music file including at least one music attribute;
comparing the music attribute to the music preference; and
downloading the music file based on the comparison.

2. The method of claim 1 further comprising, viewing a progression of network downloading of music files as a function of an emotional interface.

3. The method of claim 1 further comprising, downloading a second music file based on the first music file, as a function of a complete album feature.

4. The method of claim 1 further comprising, providing interaction with the network downloading of music files as a function of a graphical user interface.

5. The method of claim 1 further comprising, providing interaction with the network downloading of music files as a function of a voice command.

6. The method of claim 1 wherein the music preference is selected from a group consisting of an artist name, year of recording, label of distributor, title of song, and title of album.

7. The method of claim 1 wherein the music preference is obtained from a user preference collection.

8. The method of claim 1 wherein comparing the music attribute to the music preference is a function of a music collection agent.

9. The method of claim 1 wherein accessing the network based music file is a function of an agent selected from a group consisting of a freed agent, a chart agent, and an opennap agent.

10. The method of claim 1 wherein the music file is downloaded to a music playing device.

11. A system for network downloading of music files comprising:
means for obtaining at least one music preference;
means for accessing at least one network based music file, the music file including at least one music attribute;
means for comparing the music attribute to the music preference; and
means for downloading the music file based on the comparison.

12. The system of claim 11 further comprising means for viewing a progression of network downloading of music files.

13. The system of claim 11 further comprising means for downloading a second music file based on the first music file, as a function of a complete album feature.

14. The system of claim 11 further comprising means for providing interaction with the network downloading of music files as a function of a graphical user interface.

15. The system of claim 11 further comprising means for providing interaction with the network downloading of music files as a function of a voice command.

16. A computer readable medium storing a computer program for network downloading of music files comprising:
computer readable code for obtaining at least one music preference;
computer readable code for accessing at least one network based music file, the music file including at least one music attribute;
computer readable code for comparing the music attribute to the music preference; and
computer readable code for downloading the music file based on the comparison.

17. The computer readable medium of claim 16 further comprising computer readable code for viewing a progression of network downloading of music files as a function of an emotional interface.

18. The computer readable medium of claim 16 further comprising computer readable code for downloading a second music file based on the first music file, as a function of a complete album feature.

19. The computer readable medium of claim 16 further comprising computer readable code for providing interaction with the network downloading of music files as a function of a graphical user interface.

20. The computer readable medium of claim 16 further comprising computer readable code for providing interaction with the network downloading of music files as a function of a voice command.
